(19) United States
(12) Patent Application Publication
(10) Pub. No.: US 2020/0225685 A1
(43) Pub. Date: Jul. 16, 2020

(54) METHOD FOR INDICATING INFORMATION OF UNMANNED AERIAL VEHICLE, UNMANNED AERIAL VEHICLE, AND GROUND EQUIPMENT

(71) Applicant: SZ DJI TECHNOLOGY CO., LTD., Shenzhen (CN)

(72) Inventors: Yang LI, Shenzhen (CN); Zhenhao ZHOU, Shenzhen (CN); Ye TAO, Shenzhen (CN)

(21) Appl. No.: 16/829,900

(22) Filed: Mar. 25, 2020

Related U.S. Application Data
(63) Continuation of application No. PCT/CN2017/108728, filed on Oct. 31, 2017.

(51) Int. Cl. G05D 1/10; B64C 39/02; B64D 47/02; G01S 19/42

(52) U.S. Cl. CPC G05D 1/101; B64C 39/024; B64C 2201/141; G01S 19/42; B64C 2201/027; B64D 47/02

(57) ABSTRACT

A method for prompting information of an unmanned aerial vehicle, an unmanned aerial vehicle, and a ground terminal device are provided. The method includes: acquiring status information of the unmanned aerial vehicle; and transmitting the status information of the unmanned aerial vehicle to a ground terminal device, such that the ground terminal device acquires audio prompt information corresponding to the status information according to the status information of the unmanned aerial vehicle and performs an audio prompt according to the audio prompt information.

### CROSS-REFERENCE TO RELATED APPLICATION

This application is a continuation of International Application No. PCT/CN2017/108728, filed at Oct. 31, 2017, the entire content of which is incorporated herein by reference.

### TECHNICAL FIELD

The present disclosure relates to the field of unmanned aerial vehicle and, more particularly, to a method for indicating information of an unmanned aerial vehicle, an unmanned aerial vehicle, and a ground equipment (or a ground terminal device).

### BACKGROUND

Unmanned aerial vehicles can be used in aerial photography, agriculture, plant protection, selfie, film and television shooting, courier transportation, disaster rescue, or other occasions.

To ensure the safe flight of an unmanned aerial vehicle, it is necessary to monitor status information of the unmanned aerial vehicle when the unmanned aerial vehicle is in flight. Generally, a controller in the unmanned aerial vehicle can use working data of components including an inertial measurement unit, an angular velocity meter, a magnetic field sensor, or a global position system (GPS) to determine whether the unmanned aerial vehicle is in an abnormal condition. When the unmanned aerial vehicle is in an abnormal condiction, the unmanned aerial vehicle can provide audio prompts.

However, the audio prompts from the unmanned aerial vehicle are usually covered by the propeller sound of the unmanned aerial vehicle, and the audio prompts from the unmanned aerial vehicle cannot serve as an effective prompt.

### SUMMARY

One aspect of the present disclosure provides a method for prompting information of an unmanned aerial vehicle. The method includes: acquiring status information of the unmanned aerial vehicle; and transmitting the status information of the unmanned aerial vehicle to a ground terminal device, such that the ground terminal device acquires audio prompt information corresponding to the status information according to the status information of the unmanned aerial vehicle and performs an audio prompt according to the audio prompt information.

Another aspect of the present disclosure provides an unmanned aerial vehicle. The unmanned aerial vehicle includes a vehicle body, a propulsion system, a flight controller, a sensor system, and a communication system. The propulsion system is coupled to the vehicle body to provide flight propulsion. The flight controller is connected to the propulsion system communicatively, to control the flight of the unmanned aerial vehicle. The flight controller includes one or more processor. The one or more processor is used to acquire the status information of the unmanned aerial vehicle. The communication system is connected to the flight controller communicatively, and is used to transmitted the status information of the unmanned aerial vehicle to the ground terminal device. The ground terminal device acquires the audio prompt information corresponding to the status information, and perform the audio prompt according to the audio prompt information.

Another aspect of the present disclosure provides a ground terminal device. The ground terminal device includes a first communication interface and a processor. The first communication interface is used to receive the status information of the unmanned aerial vehicle from the unmanned aerial vehicle. The processor is used to acquire the audio prompt information corresponding to the status information according to the status information of the unmanned aerial vehicle, and control the acoustics module to perform audio prompt according to the audio prompt information.

In the present disclosure, the status information of the unmanned aerial vehicle may be acquired and transmitted to the ground terminal device. The ground terminal device may acquire the audio prompt information corresponding to the status information according to the status information of the unmanned aerial vehicle, and then perform audio prompt according to the audio prompt information. Audio prompt played by the unmanned aerial vehicle covered by the propeller sound of the unmanned aerial vehicle may be avoided, and the audio prompt played by the ground terminal device may effectively prompt users of the status of the unmanned aerial vehicle.

Other aspects or embodiments of the present disclosure can be understood by those skilled in the art in light of the description, the claims, and the drawings of the present disclosure.

### BRIEF DESCRIPTION OF THE DRAWINGS

FIG. 1 illustrates an exemplary method for prompting information of an unmanned aerial vehicle consistent with various embodiment of the present disclosure;

FIG. 2 illustrates an exemplary communication system consistent with various embodiment of the present disclosure;

FIG. 3 illustrates another exemplary communication system consistent with various embodiment of the present disclosure;

FIG. 4 illustrates another exemplary communication system consistent with various embodiment of the present disclosure;

FIG. 5 illustrates another exemplary communication system consistent with various embodiment of the present disclosure;

FIG. 6 illustrates another exemplary method for prompting information of an unmanned aerial vehicle consistent with various embodiment of the present disclosure;

FIG. 7 illustrates another exemplary method for prompting information of an unmanned aerial vehicle consistent with various embodiment of the present disclosure;

FIG. 8 illustrates another exemplary method for prompting information of an unmanned aerial vehicle consistent with various embodiment of the present disclosure;

FIG. 9 illustrates another exemplary method for prompting information of an unmanned aerial vehicle consistent with various embodiment of the present disclosure;

FIG. 10 illustrates another exemplary communication system consistent with various embodiment of the present disclosure;

FIG. 11 illustrates another exemplary method for prompting information of an unmanned aerial vehicle consistent with various embodiment of the present disclosure;

FIG. 12 illustrates another exemplary method for prompting information of an unmanned aerial vehicle consistent with various embodiment of the present disclosure;

FIG. 13 illustrates another exemplary method for prompting information of an unmanned aerial vehicle consistent with various embodiment of the present disclosure;

FIG. 14 illustrates another exemplary method for prompting information of an unmanned aerial vehicle consistent with various embodiment of the present disclosure;

FIG. 15 illustrates another exemplary communication system consistent with various embodiment of the present disclosure;

FIG. 16 illustrates another exemplary method for prompting information of an unmanned aerial vehicle consistent with various embodiment of the present disclosure;

FIG. 17 illustrates another exemplary method for prompting information of an unmanned aerial vehicle consistent with various embodiment of the present disclosure;

FIG. 18 illustrates an exemplary unmanned aerial vehicle consistent with various embodiment of the present disclosure;

FIG. 19 illustrates another exemplary unmanned aerial vehicle consistent with various embodiment of the present disclosure;

FIG. 20 illustrates an exemplary ground device consistent with various embodiment of the present disclosure;

FIG. 21 illustrates another exemplary unmanned aerial vehicle consistent with various embodiment of the present disclosure; and

FIG. 22 illustrates another exemplary ground device consistent with various embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

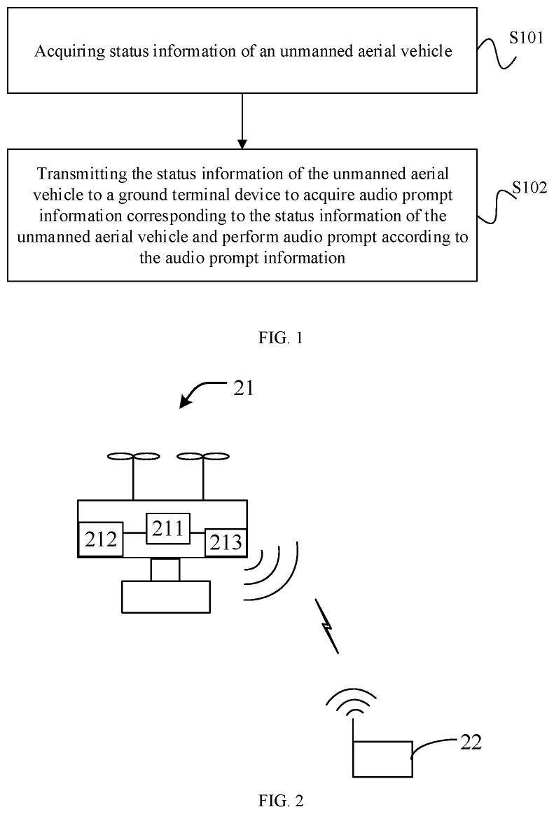

The present disclosure provides a method for prompting information of an unmanned aerial vehicle. FIG. 1 illustrates a method for prompting information of an unmanned aerial vehicle provided by one embodiment of the present disclosure, and the method can be applied to an unmanned aerial vehicle. The method may include:

S101: acquiring status information of the unmanned aerial vehicle; and

S102: transmitting the status information of the unmanned aerial vehicle to a ground equipment, such as a ground terminal device, such that the ground terminal device acquires audio prompt information corresponding to the status information of the unmanned aerial vehicle and performs an audio prompt according to the audio prompt information.

An execution subject of the method of the present disclosure may be a flight controller of the unmanned aerial vehicle, another general-purpose processor, or another special-purpose processor. For description purposes only, the embodiment where the execution subject is the flight controller is used as an example to illustrate the present disclosure, and should not limit the scopes of the present disclosure. As illustrated in FIG. 2 the unmanned aerial vehicle 21 may include a flight controller 211, a sensor system 212, and a communication system 213.

A variety of sensors including a satellite position system, a barometer, an accelerometer, an inertial measurement unit, a magnetic field sensor, an ultrasonic sensor, a vision sensor, a time-to-flight (TOF) sensor, may be disposed on the unmanned aerial vehicle 21, to form the sensor system 212 of the unmanned aerial vehicle 21. The flight controller 211 may acquire the status information the unmanned aerial vehicle 21 through the sensor system 212.

In one embodiment, acquiring the status information of the unmanned aerial vehicle may include: acquiring flight status parameters of the unmanned aerial vehicle measured by the sensor system of the unmanned aerial vehicle; and determining the status information of the unmanned aerial vehicle according to the flight status parameters of the unmanned aerial vehicle.

In one embodiment, the sensor system of the unmanned aerial vehicle may include at least one of a satellite position system, a barometer, an accelerometer, an inertial measurement unit, a magnetic field sensor, an ultrasonic sensor, a vision sensor, or a TOF sensor.

The flight status parameters of the unmanned aerial vehicle may include at least one of position information, acceleration, speed, attitude, or altitude relative to the ground.

In one embodiment, the satellite position system may detect the position information of the unmanned aerial vehicle. The satellite position system may be a GPS positioning module, and the positioning information may be GPS positioning information. The barometer may be used to detect the altitude of the unmanned aerial vehicle. The accelerometer may be used to detect the acceleration of the unmanned aerial vehicle. The flight controller may determine the speed of the unmanned aerial vehicle according to the acceleration. The inertial measurement unit may be used to detect the acceleration of the unmanned aerial vehicle and three-axis attitude of the unmanned aerial vehicle. The three-axis attitude may include a pitch angle, a roll angle, and a yaw angle. The magnetic field sensor may be a compass. At least one of an ultrasonic sensor, a vision sensor, or a TOF sensor may be used to detect whether there is an obstacle around the unmanned aerial vehicle, and to detect distance, position, and angle of the obstacle relative to the unmanned aerial vehicle. At least one of an ultrasonic sensor, a vision sensor, or a TOF sensor may also be used to detect the altitude of the unmanned aerial vehicle relative to the ground.

In one embodiment, the status information of the unmanned aerial vehicle may include the flight status parameters of the unmanned aerial vehicle. The flight controller 211 may use the flight status parameters of the unmanned aerial vehicle such as the positioning information, the acceleration, the speed, the attitude, or the altitude relative to the ground, which are determined by the sensor system 212, as the status information of the unmanned aerial vehicle.

In another embodiment, determining the status information of the unmanned aerial vehicle according to the flight status parameters of the unmanned aerial vehicle may include at least one of: determining whether the unmanned aerial vehicle is in a take-off state according to the flight status parameters of the unmanned aerial vehicle; determining whether the unmanned aerial vehicle is in a cruise state according to the flight status parameters of the unmanned aerial vehicle; or determining whether the unmanned aerial vehicle is in a landing state according to the flight status parameters of the unmanned aerial vehicle.

The flight controller may determine the status information of the unmanned aerial vehicle according to the flight status parameters of the unmanned aerial vehicle. For example, the flight controller may determine whether the unmanned aerial vehicle is in a take-off state, a cruise state, or a landing state, according to the vertical acceleration, the speed, the altitude relative to the ground of the unmanned aerial vehicle. For example, the unmanned aerial vehicle may be in the take-off state if the vertical acceleration of the unmanned aerial vehicle is larger than a preset acceleration and/or the altitude relative to the ground continuously increases. The unmanned aerial vehicle may be in the cruise state if the altitude relative to the ground of the unmanned aerial vehicle is larger than a preset altitude and is kept in a preset altitude range. The unmanned aerial vehicle may be in the landing state if the altitude relative to the ground of the unmanned aerial vehicle continuously decreases and the speed of the unmanned aerial vehicle along the vertical position continuously decreases.

In another embodiment, the status information of the unmanned aerial vehicle may include failure information of the unmanned aerial vehicle. The flight controller may also determine whether the unmanned aerial vehicle is in a fault state according to the flight status parameters of the unmanned aerial vehicle.

In another embodiment, the status information of the unmanned aerial vehicle may include the obstacle information around the unmanned aerial vehicle. At least one of the ultrasonic sensor, the vision sensor, or the TOF sensor may determine whether there is an obstacle around the unmanned aerial vehicle, and determine the distance, the position, or then angle of the obstacle relative to the unmanned aerial vehicle.

After the flight controller 211 detects the status information of the unmanned aerial vehicle, the unmanned aerial vehicle 21 may transmit the status information of the unmanned aerial vehicle 21 to a ground terminal device 22 through the communication system 213. The ground terminal device 22 may be a remote controller, a smartphone, a tablet, a ground control station, a laptop, a watch, a bracelet, or a combination thereof. A correspondence between the status information and audio prompt information of the unmanned aerial vehicle 21 may be stored in the ground terminal device 22 in advance. After receiving the status information of the unmanned aerial vehicle 21, the ground terminal device 22 may acquire the audio prompt information corresponding to the status information, and play the audio prompt information to achieve audio prompt with respect to the status information.

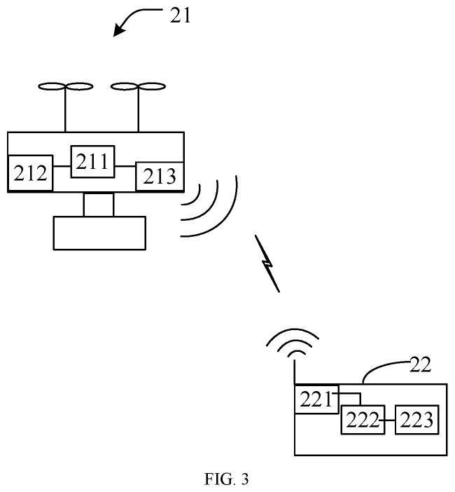

As illustrated in FIG. 3, the ground terminal device 22 may include a communication interface 221, a processor 222, and an acoustics module 223. The communication interface 221 may receive the status information from the unmanned aerial vehicle 21 and send the status information of the unmanned aerial vehicle 21 to the processor 222. Then the processor 222 may acquire the audio prompt information corresponding to the status information according to the status information of the unmanned aerial vehicle 21, and output the audio prompt information to the acoustics module 223. The acoustics module 223 then may play the audio prompt corresponding to the status information. The acoustics module 223 may be a device capable of generating sound such as a speaker or a buzzer. The present disclosure has no limits on the specific form of the acoustics module.

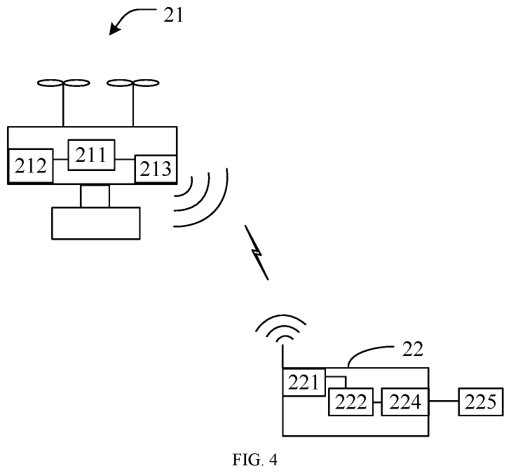

In some other embodiments, the ground terminal device 22 may not include the acoustics module. The acoustics module may be a peripheral device of the ground terminal device 22. As illustrated in FIG. 4, the ground terminal device 22 may be connected to a peripheral acoustics module 225 through a communication interface 224. In various embodiments, the communication interface 224 may be connected to the acoustics module 225 wired or wirelessly. For description purposes only, the present embodiment in FIG. 4 where the communication interface 224 may be connected to the acoustics module 225 wired is used as an example to illustrate the present disclosure and should not limit the scopes of the present disclosure. The communication interface 224 may be a wired communication interface of the ground terminal device 22 and the communication interface 221 may be a wireless communication interface of the ground terminal device. In other embodiments, the communication interface 224 may be a wireless communication interface of the ground terminal device 22, too.

In one embodiment, when the communication interface 221 of the ground terminal device 22 receives the status information of the unmanned aerial vehicle indicating that the unmanned aerial vehicle is in the take-off state, the processor 222 may acquire audio signal corresponding to sound generated by aerial vehicles such as helicopters or large airplanes in the take-off state which is stored in advance, and use the audio signal as the audio prompt information indicating the unmanned aerial vehicle 21 is in the take-off state. The processor 222 may transmit the audio prompt information to the acoustics module 223 as illustrated in FIG. 3 or to the peripheral acoustics module 225 connected to the ground terminal device 22 through the communication interface 224 as illustrated in FIG. 4. The acoustics module 223 or the acoustics module 225 may generate sound produced by aerial vehicles such as helicopters or large airplanes in the take-off state according to the audio prompt information, to prompt users that the unmanned aerial vehicle is taking off now.

In one embodiment, when the communication interface 221 of the ground terminal device 22 receives the status information of the unmanned aerial vehicle indicating that the unmanned aerial vehicle is in the cruise state, the processor 222 may acquire audio signal corresponding to sound generated by aerial vehicles such as helicopters or large airplanes in the cruise state which is stored in advance, and use the audio signal as the audio prompt information indicating the unmanned aerial vehicle 21 is in the cruise state. The processor 222 may transmit the audio prompt information to the acoustics module 223 as illustrated in FIG. 3 or to the peripheral acoustics module 225 connected to the ground terminal device 22 through the communication interface 224 as illustrated in FIG. 4. The acoustics module 223 or the acoustics module 225 may generate sound produced by aerial vehicles such as helicopters or large airplanes in the cruise state according to the audio prompt information, to prompt users that the unmanned aerial vehicle is in the cruise state now.

In one embodiment, when the communication interface 221 of the ground terminal device 22 receives the status information of the unmanned aerial vehicle indicating that the unmanned aerial vehicle is in the landing state, the processor 222 may acquire audio signal corresponding to sound generated by aerial vehicles such as helicopters or large airplanes in the landing state which is stored in advance, and use the audio signal as the audio prompt information indicating the unmanned aerial vehicle 21 is in the landing state. The processor 222 may transmit the audio prompt information to the acoustics module 223 as illustrated in FIG. 3 or to the peripheral acoustics module 225 connected to the ground terminal device 22 through the communication interface 224 as illustrated in FIG. 4. The acoustics module 223 or the acoustics module 225 may generate sound produced by aerial vehicles such as helicopters or large airplanes in the landing state according to the audio prompt information, to prompt users that the unmanned aerial vehicle is landing now.

In one embodiment, when the communication interface 221 of the ground terminal device 22 receives the speed of the unmanned aerial vehicle, the processor 222 may determine whether the speed of the unmanned aerial vehicle is fast or slow, and then control the acoustics module to play beep sound with different frequencies according to the speed of the unmanned aerial vehicle. For example, the processor 222 may control the acoustics module to play the beep sound with a higher frequency if the speed of the unmanned aerial vehicle is larger. The processor 222 may control the acoustics module to play the beep sound with a lower frequency if the speed of the unmanned aerial vehicle is smaller.

In one embodiment, when the communication interface 221 of the ground terminal device 22 receives the positioning information of the unmanned aerial vehicle, the processor 222 may determine whether the unmanned aerial vehicle arrives at a preset destination according to the positioning information of the unmanned aerial vehicle, and then control the unmanned aerial vehicle to play broadcast messages. In one embodiment, the unmanned aerial vehicle may include an acoustics module. As illustrated in FIG. 5, the unmanned aerial vehicle 21 may include an acoustics module 214. In various embodiments, the ground terminal device 22 may control the unmanned aerial vehicle 21 to play broadcast messages in various ways.

In one embodiment, when the processor 222 determines that the unmanned aerial vehicle 21 arrives at the preset destination, the processor 222 may send a control instruction to the unmanned aerial vehicle 21 through the communication interface 221, and the control instruction may control the unmanned aerial vehicle 21 to play the broadcast messages. The communication system 213 of the unmanned aerial vehicle 21 may receive the control instruction and transmit the control instruction to the flight controller 211. The flight controller 211 may control the acoustics module 214 to play the broadcast messages stored in advance.

In another embodiment, when the processor 222 determines that the unmanned aerial vehicle 21 arrives at the preset destination, the processor 222 may send an audio information to the unmanned aerial vehicle 21 through the communication interface 221. The audio information may include the broadcast messages. The audio information may be voice information stored in the ground terminal device 22 in advance or users' audio information recorded by a voice recording device in the ground terminal device 22. The communication system 213 of the unmanned aerial vehicle 21 may receive the audio information and transmit the audio information to the flight controller 211. The flight controller 211 may control the acoustics module 214 to play the audio information.

In one embodiment, when at least one of the ultrasonic sensor, the vision sensor, or the TOF sensor of the unmanned aerial vehicle 21 detects an obstacle around the unmanned aerial vehicle 21, the flight controller 211 may send the obstacle information including distance, position, and angle of the obstacle relative to the unmanned aerial vehicle 21 to the ground terminal device 22 through the communication system 213. The processor 222 of the ground terminal device 22 may acquire audio prompt information corresponding to the obstacle, and then control the acoustics module 223 or the acoustics module 225 to play the audio prompt information, to remind users for the obstacle around the unmanned aerial vehicle.

In one embodiment, when the flight controller 211 detects a fault the unmanned aerial vehicle 21, the flight controller 211 may send the fault information to the unmanned aerial vehicle 21 to the ground terminal device 22 through the communication system 213. The processor 222 of the ground terminal device 22 may acquire audio prompt information corresponding to the fault information and then control the acoustics module 223 or the acoustics module 225 to play the audio prompt information, to remind users for the fault of the unmanned aerial vehicle.

In one embodiment, when component parameters of the unmanned aerial vehicle 21 including a bracket angle or a compass of the unmanned aerial vehicle 21 need calibration, the processor 222 of the ground terminal device 22 may control the acoustics module 223 or the acoustics module 225 to play audio prompt information corresponding to the calibration operation, to prompt users to control the ground terminal device 22 according to the calibration operation played by the acoustics module. When the ground terminal device 22 is a remote controller of the unmanned aerial vehicle 21, the users may control a joystick of the remote controller according to the calibration operation played by the acoustics module, to calibrate the bracket angle or the compass.

In one embodiment, the ground terminal device 22 may be a remote controller of the unmanned aerial vehicle 21, and a control mode selection button may be disposed at the remote controller of the unmanned aerial vehicle 21. If a fresh user just getting started is not familiar with the remote controller and cannot control the flight of the unmanned aerial vehicle 21 stably, the user can click the control mode selection button disposed at the remote controller of the unmanned aerial vehicle 21. The remote controller may control the acoustics module in the remote controller to play voice instructions, to prompt the user how to operate the remote controller to control the unmanned aerial vehicle.

In the present disclosure, the status information of the unmanned aerial vehicle may be acquired and transmitted to the ground terminal device. The ground terminal device may acquire the audio prompt information corresponding to the status information according to the status information of the unmanned aerial vehicle, and then perform audio prompt according to the audio prompt information. Audio prompt played by the unmanned aerial vehicle covered by the propeller sound of the unmanned aerial vehicle may be avoided, and the audio prompt played by the ground terminal device may effectively prompt users of the status of the unmanned aerial vehicle.

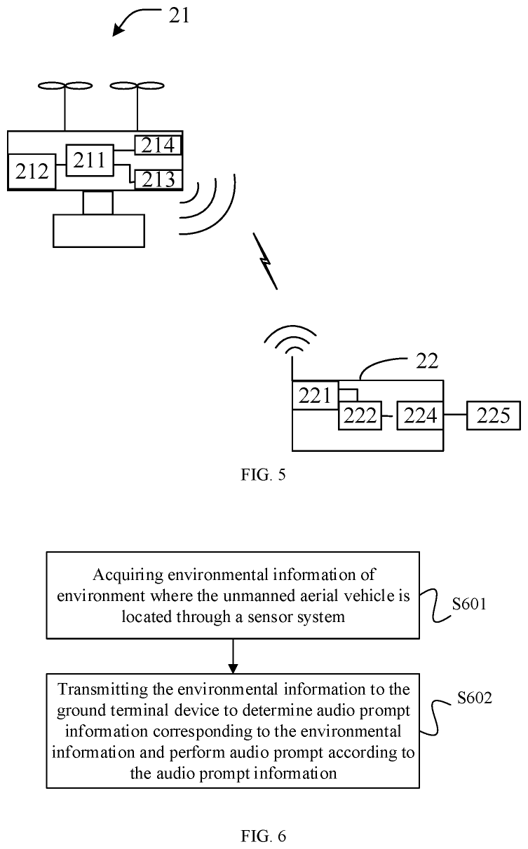

The present disclosure provides another method for prompting information of the unmanned aerial vehicle. As illustrated in FIG. 6, based on the method provided by the embodiment illustrated in FIG. 1, the method may include:

S601: acquiring environmental information of environment where the unmanned aerial vehicle is located through the sensor system of the unmanned aerial vehicle; and

S602: transmitting the environmental information to the ground terminal device, to make the ground terminal device determine audio prompt information corresponding to the environmental information and perform audio prompt according to the audio prompt information.

The sensor system may include at least one of a barometer, a wind speed sensor, a temperature sensor, or an atmospheric density sensor.

The environmental information of the environment where the unmanned aerial vehicle is located may include at least one of atmospheric temperature, atmospheric pressure, atmospheric density, or wind speed.

In the present embodiment, the sensor system 212 of the unmanned aerial vehicle 21 may include a barometer, a wind speed sensor, a temperature sensor, or an atmospheric density sensor. The barometer may detect atmospheric pressure of the environment where the unmanned aerial vehicle 21 is located. The wind speed sensor may detect the wind speed of the environment where the unmanned aerial vehicle 21 is located. The temperature sensor may detect the temperature of the environment where the unmanned aerial vehicle 21 is located. The atmospheric density sensor may detect the atmospheric density of the environment where the unmanned aerial vehicle 21 is located.

The flight controller 211 may acquire the environmental information of the environment where the unmanned aerial vehicle 21 is located detected by the sensor system 212, including atmospheric temperature, atmospheric pressure, atmospheric density, or wind speed.

The flight controller 211 may send the environmental information of the environment where the unmanned aerial vehicle 21 is located including atmospheric temperature, atmospheric pressure, atmospheric density, or wind speed, to the ground terminal device 22 through the communication system 213. The ground terminal device 22 may determine the audio prompt information corresponding to the environmental information, and then control the acoustics module 223 or the acoustics module 225 to play the audio prompt information, to prompt the users of the environmental status of the environment where the unmanned aerial vehicle 21 is located.

In the present disclosure, the environmental information of the environment where the unmanned aerial vehicle is located may be acquired and transmitted to the ground terminal device. The ground terminal device may acquire the audio prompt information corresponding to the environmental information according to the environmental information of the unmanned aerial vehicle, and then perform audio prompt according to the audio prompt information, to prompt the users of the environmental status of the environment where the unmanned aerial vehicle 21 is located. Coverage of audio prompt from the unmanned aerial vehicle covered by the propeller sound of the unmanned aerial vehicle may be avoided, and the audio prompt played by the ground terminal device may effectively prompt users of the environmental status of the unmanned aerial vehicle.

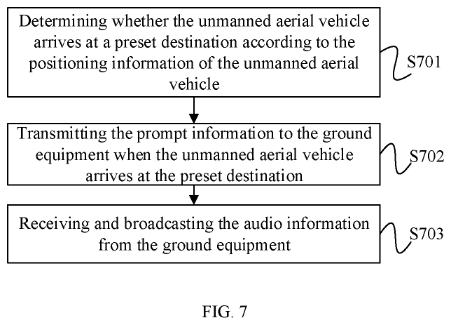

The present disclosure provides another method for prompting information of the unmanned aerial vehicle. As illustrated in FIG. 7, based on the embodiment illustrated in FIG. 1 or the embodiment illustrated in FIG. 6, the method may include:

S701: determining whether the unmanned aerial vehicle arrives at a preset destination according to the positioning information of the unmanned aerial vehicle;

S702: transmitting the prompt information to the ground terminal device when the unmanned aerial vehicle arrives at the preset destination, where the prompt information may be used to prompt the users that the unmanned aerial vehicle arrives at the preset destination; and

S703: receiving and broadcasting the audio information from the ground terminal device.

The satellite positioning device in the unmanned aerial vehicle 21 may detect the positioning information of the unmanned aerial vehicle 21. The satellite positioning device may be a GPS positioning module, and the positioning information may be GPS positioning information. The flight controller 211 may determine whether the unmanned aerial vehicle 21 arrives at the preset destination according to the GPS positioning information of the unmanned aerial vehicle 21.

When the flight controller 211 determines that the unmanned aerial vehicle 21 arrives at the preset destination, the flight controller 211 may transmit the prompt information to the ground terminal device 22 through the communication system 213. The prompt information may be used to prompt the ground terminal device 22 that the unmanned aerial vehicle 21 arrives at the preset destination.

When the ground terminal device 22 receives the prompt information through the communication system 213, the ground terminal device 22 may send audio information to the unmanned aerial vehicle 21. The audio information may be audio information recorded by the ground terminal device 22 through the audio recording device. Broadcasting the audio information from the ground terminal device may include broadcasting the audio information from the ground terminal device through the acoustics module of the unmanned aerial vehicle.

In one embodiment, the ground terminal device 22 may include an audio recording device such as a microphone. After the microphone records the user's audio information, the ground terminal device 22 may send the user's audio information to the unmanned aerial vehicle 21. The unmanned aerial vehicle 21 may play the user's audio information through the acoustics module 214, to make unmanned aerial vehicle 21 play the user's audio information when the unmanned aerial vehicle 21 arrives at the preset destination. The preset destination may not be covered by wire broadcast. By controlling the unmanned aerial vehicle to fly to the preset destination and to play the user's audio information recorded by the ground terminal device, wireless broadcast may be achieved in regions not covered by the wired broadcast.

In the present disclosure, the unmanned aerial vehicle may fly to the preset destination and then play the user's audio information recorded by the ground terminal device. The preset destination may not be covered by wire broadcast. By controlling the unmanned aerial vehicle to fly to the preset destination and to play the user's audio information recorded by the ground terminal device, wireless broadcast may be achieved in regions not covered by the wired broadcast.

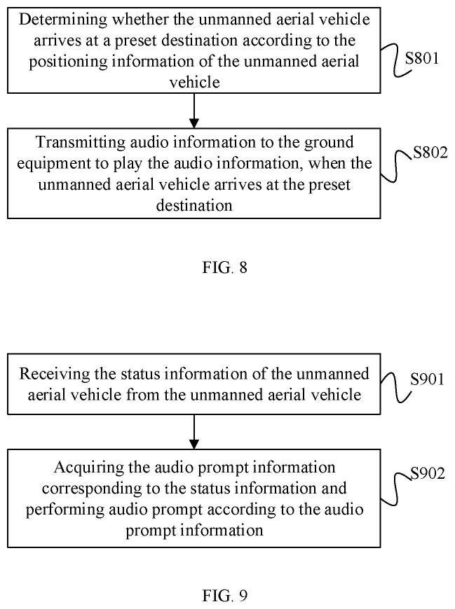

The present disclosure provides another method for prompting information of the unmanned aerial vehicle. As illustrated in FIG. 8, based on the embodiment illustrated in FIG. 1 or the embodiment illustrated in FIG. 6, the method may include:

S801: determining whether the unmanned aerial vehicle arrives at a preset destination according to the positioning information of the unmanned aerial vehicle; and

S802: transmitting audio information to the ground terminal device to make the ground terminal device play the audio information, when the unmanned aerial vehicle arrives at the preset destination.

The satellite positioning device in the unmanned aerial vehicle 21 may detect the positioning information of the unmanned aerial vehicle 21. The satellite positioning device may be a GPS positioning module, and the positioning information may be GPS positioning information. The flight controller 211 may determine whether the unmanned aerial vehicle 21 arrives at the preset destination according to the GPS positioning information of the unmanned aerial vehicle 21.

The audio information may be audio information recorded by an audio recording device of the unmanned aerial vehicle.

In one embodiment, the ground terminal device 22 may include an audio recording device such as a microphone. When the flight controller 211 determines that the unmanned aerial vehicle 21 arrives at the preset destination, the flight controller 211 may control the microphone to record the audio information, and then transmit the audio information recorded by the microphone to the ground terminal device 22 through the communication system 213. The ground terminal device 22 may play the audio information recorded by the microphone of the unmanned aerial vehicle 21 through the acoustics module 223 or the acoustics module 225. The users may receive the audio information recorded by the unmanned aerial vehicle 21 at the preset destination through the ground terminal device 22.

In the present disclosure, the audio information may be recorded after the unmanned aerial vehicle arrives at the preset destination and then be transmitted to the ground terminal device. The preset destination may not be covered by wire broadcast. The users may receive the audio information recorded by the unmanned aerial vehicle at the preset destination through the ground terminal device.

The present disclosure provides another method for prompting information of the unmanned aerial vehicle. The method may be applied to the ground terminal device. As illustrated in FIG. 9, the method may include:

S901: receiving the status information of the unmanned aerial vehicle from the unmanned aerial vehicle; and

S902: acquiring the audio prompt information corresponding to the status information and performing audio prompt according to the audio prompt information.

The execution subject of the method may be the ground terminal device 22.

The unmanned aerial vehicle 21 may include a plurality of sensors including a satellite position system, a barometer, an accelerometer, an inertial measurement unit, a magnetic field sensor, an ultrasonic sensor, a vision sensor, or a TOF sensor. The plurality of sensors may constitute the sensor system 212 of the unmanned aerial vehicle 21 together. The flight controller 211 may acquire the status information of the unmanned aerial vehicle 21 through the sensor system 212 and then may transmit the status information of the unmanned aerial vehicle 21 to the ground terminal device 22 through the communication system 213. The ground terminal device 22 may receive the status information of the unmanned aerial vehicle 21 sent by the unmanned aerial vehicle through the communication interface 221.

In one embodiment, the status information of the unmanned aerial vehicle may include the flight status parameters of the unmanned aerial vehicle. The flight status parameters of the unmanned aerial vehicle may include at least one of the positioning information, the acceleration, the speed, the attitude, or the altitude relative to the ground.

In another embodiment, the status information of the unmanned aerial may include at least one of: the unmanned aerial vehicle is in a take-off state, the unmanned aerial vehicle is in a cruise state, or the unmanned aerial vehicle is in a landing state.

In another embodiment, the status information of the unmanned aerial vehicle may include failure information of the unmanned aerial vehicle.

In another embodiment, the status information of the unmanned aerial vehicle may include the obstacle information around the unmanned aerial vehicle.

The communication interface 221 of the ground terminal device 22 may receive the status information from the unmanned aerial vehicle 21 and then send the status information of the unmanned aerial vehicle 21 to the processor 222 of the ground terminal device 22. Then the processor 222 may acquire the audio prompt information corresponding to the status information according to the status information of the unmanned aerial vehicle 21, and control the acoustics module 223 or the acoustics module 225 to play the audio prompt information, to prompt the user for the current status of the unmanned aerial vehicle.

In one embodiment, acquiring the audio prompt information corresponding to the status information and performing audio prompt according to the audio prompt information may include: querying a preset one-to-one correspondence between a plurality of reference status information and a plurality of audio prompt information according to the status information of the unmanned aerial vehicle, to acquire the audio prompt information corresponding to reference status information matching the status information of the unmanned aerial vehicle. For example, the ground terminal device 22 may store the one-to-one correspondence between a plurality of reference status information and a plurality of audio prompt information. Each of the plurality of reference status information may be the status information of the unmanned aerial vehicle including the status information indicating that the unmanned aerial vehicle is in fault, the status information indicating that there is an obstacle around the unmanned aerial vehicle, an altitude of the unmanned aerial vehicle relative to the ground, and a flight speed of the unmanned aerial vehicle. When the ground terminal device 22 receives the current status information of the unmanned aerial vehicle 21 from the unmanned aerial vehicle 21, the ground terminal device 22 may query reference status information matching the current status information of the unmanned aerial vehicle 21 in the one-to-one correspondence, and determine the audio prompt information corresponding to the reference status information as the audio prompt information to prompt for the current status of the unmanned aerial vehicle 21.

In another embodiment, acquiring the audio prompt information corresponding to the status information and performing audio prompt according to the audio prompt information may include: acquiring the audio prompt information corresponding to the status information of the unmanned aerial vehicle from the internet, according to the status information of the unmanned aerial vehicle. Acquiring the audio prompt information corresponding to the status information of the unmanned aerial vehicle from the internet according to the status information of the unmanned aerial vehicle may include: querying a preset one-to-one correspondence between a plurality of reference status information and a plurality of links according to the status information of the unmanned aerial vehicle, to acquire a link corresponding to the reference status information matching the status information of the unmanned aerial vehicle, where each link of the plurality of links points to an audio prompt information; and acquiring the audio prompt information indicated by the link from the internet according to the link corresponding to the reference status information matching the status information of the unmanned aerial vehicle.

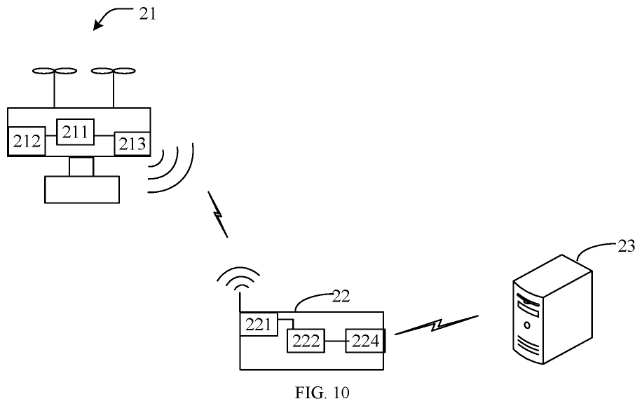

As illustrated in FIG. 10, the ground terminal device 22 may be connected to a server 23 wired or wirelessly. The ground terminal device 22 may store the preset one-to-one correspondence between the plurality of reference status information and the plurality of links. Each link of the plurality of links points to an audio prompt information. The audio prompt information corresponding to the plurality of links may be stored in the server 23. When the ground terminal device 22 receives the current status information of the unmanned aerial vehicle 21 from the unmanned aerial vehicle 21, the ground terminal device 22 may query a reference status information matching the current status information of the unmanned aerial vehicle 21 in the one-to-one correspondence, and acquire the audio prompt information pointed by the link corresponding to the reference status information to use the audio prompt information corresponding to the reference status information as the audio prompt information to prompt for the current status of the unmanned aerial vehicle 21.

In the present disclosure, the status information of the unmanned aerial vehicle may be acquired through the unmanned aerial vehicle and may be transmitted to the ground terminal device. The ground terminal device may acquire the audio prompt information corresponding to the status information according to the status information of the unmanned aerial vehicle, and then perform audio prompt according to the audio prompt information. Coverage of audio prompt from the unmanned aerial vehicle by the propeller sound of the unmanned aerial vehicle may be avoided, and the audio prompt played by the ground terminal device may effectively prompt users of the status information of the unmanned aerial vehicle.

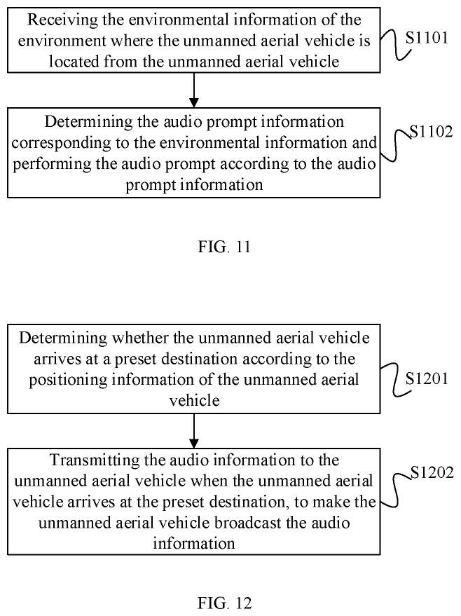

The present disclosure provides another method for prompting information of the unmanned aerial vehicle. As illustrated in FIG. 11, based on the method provided by the embodiment of the present disclosure illustrated in FIG. 9, the method may include:

S1101: receiving the environmental information of the environment where the unmanned aerial vehicle is located from the unmanned aerial vehicle; and

S1102: determining the audio prompt information corresponding to the environmental information and performing the audio prompt according to the audio prompt information.

The environmental information of the environment where the unmanned aerial vehicle is located may include at least one of atmospheric temperature, atmospheric pressure, atmospheric density, or wind speed.

In the present embodiment, the sensor system 212 of the unmanned aerial vehicle 21 may include a barometer, a wind speed sensor, a temperature sensor, or an atmospheric density sensor. The barometer may detect atmospheric pressure of the environment where the unmanned aerial vehicle 21 is located. The wind speed sensor may detect the wind speed of the environment where the unmanned aerial vehicle 21 is located. The temperature sensor may detect the temperature of the environment where the unmanned aerial vehicle 21 is located. The atmospheric density sensor may detect the atmospheric density of the environment where the unmanned aerial vehicle 21 is located.

The flight controller 211 may send the environmental information of the environment where the unmanned aerial vehicle 21 is located including atmospheric temperature, atmospheric pressure, atmospheric density, or wind speed, to the ground terminal device 22 through the communication system 213.

Performing the audio prompt according to the audio prompt information may include: transmitting the audio prompt information to the acoustics module connected to the ground terminal device to make the acoustics module perform the audio prompt.

The acoustics module may include at least one of a speaker or a buzzer.

The ground terminal device 22 may determine the audio prompt information corresponding to the environmental information, and then control the acoustics module 223 or the acoustics module 225 to play the audio prompt information, to prompt the users of the environmental status of the environment where the unmanned aerial vehicle 21 is located.

In the present disclosure, the environmental information of the environment where the unmanned aerial vehicle may be acquired by the unmanned aerial vehicle and transmitted to the ground terminal device. The ground terminal device may acquire the audio prompt information corresponding to the environmental information according to the environmental information of the unmanned aerial vehicle, and then perform audio prompt according to the audio prompt information, to prompt the users of the environmental status of the environment where the unmanned aerial vehicle 21 is located. Coverage of audio prompt from the unmanned aerial vehicle by the propeller sound of the unmanned aerial vehicle may be avoided, and the audio prompt played by the ground terminal device may effectively prompt users of the environmental status of the unmanned aerial vehicle.

The present disclosure provides another method for prompting information of the unmanned aerial vehicle. As illustrated in FIG. 12, based on the method provided by the embodiment of the present disclosure illustrated in FIG. 9 or the embodiment of the present disclosure illustrated in FIG. 11, the method may include:

S1201: determining whether the unmanned aerial vehicle arrives at a preset destination according to the positioning information of the unmanned aerial vehicle; and

S1202: transmitting the audio information to the unmanned aerial vehicle when the unmanned aerial vehicle arrives at the preset destination, to make the unmanned aerial vehicle broadcast the audio information.

When the ground terminal device 22 receives the positioning information of the unmanned aerial vehicle from the unmanned aerial vehicle, the ground terminal device 22 may determine whether the unmanned aerial vehicle 21 arrives at the preset destination according to the positioning information of the unmanned aerial vehicle 21.

The audio information may be the audio information recorded by the ground terminal device through the audio recording device.

In one embodiment, the ground terminal device 22 may further include an audio recording device such as a microphone. When the ground terminal device 22 determines that the unmanned aerial vehicle 21 arrives at the preset destination according to the positioning information of the unmanned aerial vehicle 21, the ground terminal device 22 may control the microphone to record the user's audio information. After the microphone records the user's audio information, the ground terminal device 22 may send the user's audio information to the unmanned aerial vehicle 21. The unmanned aerial vehicle 21 may play the user's audio information through the acoustics module 214, to make unmanned aerial vehicle 21 play the user's audio information when the unmanned aerial vehicle 21 arrives at the preset destination. The preset destination may not be covered by wire broadcast. By controlling the unmanned aerial vehicle to fly to the preset destination and to play the user's audio information recorded by the ground terminal device, wireless broadcast may be achieved in regions not covered by the wired broadcast.

In the present disclosure, the unmanned aerial vehicle may fly to the preset destination and then play the user's audio information recorded by the ground terminal device. The preset destination may not be covered by wire broadcast. By controlling the unmanned aerial vehicle to fly to the preset destination and to play the user's audio information recorded by the ground terminal device, wireless broadcast may be achieved in regions not covered by the wired broadcast.

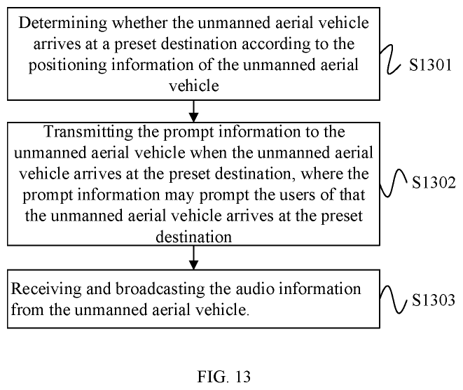

The present disclosure provides another method for prompting information of the unmanned aerial vehicle. As illustrated in FIG. 13, based on the method provided by the embodiment of the present disclosure illustrated in FIG. 9 or the embodiment of the present disclosure illustrated in FIG. 11, the method may include:

S1301: determining whether the unmanned aerial vehicle arrives at a preset destination according to the positioning information of the unmanned aerial vehicle; and

S1302: transmitting the prompt information to the unmanned aerial vehicle when the unmanned aerial vehicle arrives at the preset destination, where the prompt information may prompt the users of that the unmanned aerial vehicle arrives at the preset destination; and

S1303: receiving and broadcasting the audio information from the unmanned aerial vehicle.

When the ground terminal device 22 receives the positioning information of the unmanned aerial vehicle from the unmanned aerial vehicle, the ground terminal device 22 may determine whether the unmanned aerial vehicle 21 arrives at the preset destination according to the positioning information of the unmanned aerial vehicle 21.

When the ground terminal device 22 determines that the unmanned aerial vehicle 21 arrives at the preset destination according to the positioning information of the unmanned aerial vehicle 21, the ground terminal device 22 may send the prompt information to the unmanned aerial vehicle 21, to prompt that the unmanned aerial vehicle 21 arrives at the preset destination.

The audio information may be the audio information recorded by the ground terminal device through the audio recording device.

In one embodiment, the unmanned aerial vehicle 21 may further include an audio recording device such as a microphone. When the unmanned aerial vehicle 21 receives the prompt information from the ground terminal device, the flight controller 211 may control the microphone to record the audio information, and may send the audio information to the unmanned aerial vehicle 21 through the communication system 213. The ground terminal device 22 may play the audio information recorded by the microphone of the unmanned aerial vehicle 21 through the acoustics module 223 or the acoustics module 225. The user may listen to the audio information recorded by the microphone of the unmanned aerial vehicle 21 at the preset destination through the ground terminal device.

In the present disclosure, the unmanned aerial vehicle may record the audio information after the unmanned aerial vehicle arrives at the present destination and send the audio information to the ground terminal device. The user may listen to the audio information recorded by the microphone of the unmanned aerial vehicle at the preset destination through the ground terminal device.

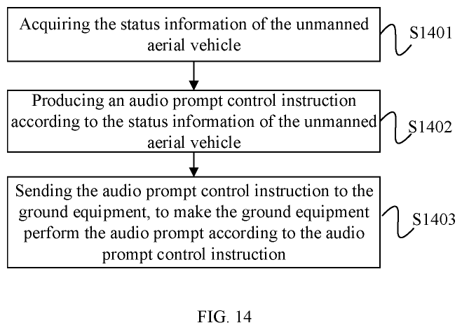

The present disclosure provides another method for prompting information of the unmanned aerial vehicle. The method may be applied to the unmanned aerial vehicle. As illustrated in FIG. 14, the method may include:

S1401: acquiring the status information of the unmanned aerial vehicle;

S1402: producing an audio prompt control instruction according to the status information of the unmanned aerial vehicle; and

S1403: sending the audio prompt control instruction to the ground terminal device, to make the ground terminal device perform the audio prompt according to the audio prompt control instruction.

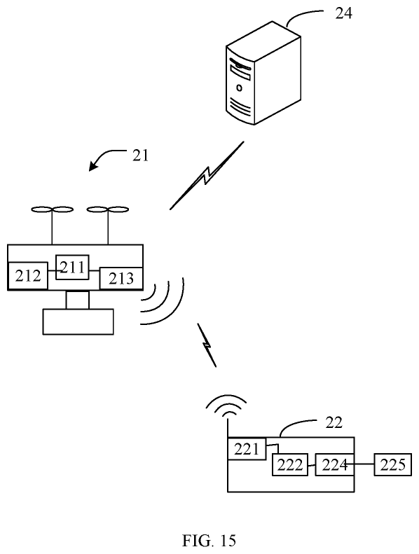

In the present embodiment, the execution subject of the method may be the unmanned aerial vehicle. As illustrated in FIG. 15, the unmanned aerial vehicle 21 may include a flight controller 211, a sensor system 212, and a communication system 213.

A variety of sensors including a satellite position system, a barometer, an accelerometer, an inertial measurement unit, a magnetic field sensor, an ultrasonic sensor, a vision sensor, a TOF sensor, may be disposed on the unmanned aerial vehicle 21, to form the sensor system 212 of the unmanned aerial vehicle 21. The flight controller 211 may acquire the status information the unmanned aerial vehicle 21 through the sensor system 212. The principle and method for the flight controller 211 to acquire the status information the unmanned aerial vehicle 21 through the sensor system 212 may be referred to S101.

The flight controller 211 may produce an audio prompt control instruction according to the status information of the unmanned aerial vehicle 21. The audio prompt control instruction may include the audio prompt information, and may be used to control the ground terminal device 22 to perform the audio prompt according to the audio prompt information in the audio prompt control instruction.

Producing an audio prompt control instruction according to the status information of the unmanned aerial vehicle may include: acquiring the audio prompt information corresponding to the status information according to the status information of the unmanned aerial vehicle; and producing the audio prompt control instruction including the audio prompt information, according to the audio prompt information.

When the flight controller 211 determines the status information of the unmanned aerial vehicle, the audio prompt information corresponding to the status information may be acquired according to the status information of the unmanned aerial vehicle; and the audio prompt control instruction may be produced corresponding to the audio prompt information. The audio prompt control instruction may include the audio prompt information.

In one embodiment, acquiring the audio prompt information corresponding to the status information may include: querying a preset one-to-one correspondence between a plurality of reference status information and a plurality of audio prompt information according to the status information of the unmanned aerial vehicle, to acquire the audio prompt information corresponding to reference status information matching the status information of the unmanned aerial vehicle.

For example, the unmanned aerial vehicle 21 may store the one-to-one correspondence between a plurality of reference status information and a plurality of audio prompt information. Each of the plurality of reference status information may be the status information of the unmanned aerial vehicle including the status information indicating that the unmanned aerial vehicle is in fault, the status information indicating that there is an obstacle around the unmanned aerial vehicle, an altitude of the unmanned aerial vehicle relative to the ground, and a flight speed of the unmanned aerial vehicle. When the flight controller 211 determines the current status information of the unmanned aerial vehicle 21, the flight controller 211 may query reference status information matching the current status information of the unmanned aerial vehicle 21 in the one-to-one correspondence, and determine the audio prompt information corresponding to the reference status information as the audio prompt information to prompt for the current status of the unmanned aerial vehicle 21.

In another embodiment, acquiring the audio prompt information corresponding to the status information may include: acquiring the audio prompt information corresponding to the status information of the unmanned aerial vehicle from the internet, according to the status information of the unmanned aerial vehicle. Acquiring the audio prompt information corresponding to the status information of the unmanned aerial vehicle from the internet according to the status information of the unmanned aerial vehicle may include: querying a preset one-to-one correspondence between a plurality of reference status information and a plurality of links according to the status information of the unmanned aerial vehicle, to acquire a link corresponding to the reference status information matching the status information of the unmanned aerial vehicle, where each link of the plurality of links points to an audio prompt information; and acquiring the audio prompt information indicated by the link from the internet according to the link corresponding to the reference status information matching the status information of the unmanned aerial vehicle.

As illustrated in FIG. 15, the unmanned aerial vehicle 21 may communicate with a server 24. The unmanned aerial vehicle 21 may store the preset one-to-one correspondence between the plurality of reference status information and the plurality of links. Each link of the plurality of links points to an audio prompt information. The audio prompt information corresponding to the plurality of links may be stored in the server 24. When the flight controller 211 determines the current status information of the unmanned aerial vehicle 21, the flight controller 211 may query a reference status information matching the current status information of the unmanned aerial vehicle 21 in the one-to-one correspondence, and acquire the audio prompt information pointed by the link corresponding to the reference status information to use the audio prompt information corresponding to the reference status information as the audio prompt information to prompt for the current status of the unmanned aerial vehicle 21.

Sending the audio prompt control instruction to the ground terminal device, to make the ground terminal device perform the audio prompt according to the audio prompt control instruction may include: sending the audio prompt control instruction to the ground terminal device, to make the ground terminal device perform the audio prompt according to the audio prompt information in the audio prompt control instruction.

The flight controller 211 may send the audio prompt control instruction determined by the flight controller 211 according to the status information of the unmanned aerial vehicle to the ground terminal device 22 through the communication system 213. After the communication interface 221 of the ground terminal device 22 receives the audio prompt control instruction, the audio prompt control instruction may be transmitted to the processor 222. The processor 222 may parse out the audio prompt information from the audio prompt control instruction and send the audio prompt information to the acoustics module 225 externally connected to the ground terminal device 22, to make the acoustics module 225 perform the audio prompt. In some other embodiments, the processor 222 may send the audio prompt information to the acoustics module 223 in the ground terminal device 22, to make the acoustics module 223 perform the audio prompt.

In the present disclosure, the status information of the unmanned aerial vehicle may be acquired through the unmanned aerial vehicle, and the audio prompt control instruction may be produced according to the status information of the unmanned aerial vehicle and may be sent to the ground terminal device. The ground terminal device may perform the audio prompt according to the audio prompt control instruction. Coverage of the audio prompt from the unmanned aerial vehicle by the propeller sound of the unmanned aerial vehicle may be avoided, and the audio prompt played by the ground terminal device may effectively prompt users of the environmental status of the unmanned aerial vehicle.

The present disclosure provides another method for prompting information of the unmanned aerial vehicle. As illustrated in FIG. 16, based on the method provided by the embodiment illustrated in FIG. 14, the method may include:

S1601: acquiring environmental information of environment where the unmanned aerial vehicle is located;

S1602: determining the audio prompt information corresponding to the environmental information according to the environmental information; and

S1603: producing the audio prompt control instruction according to the audio prompt information corresponding to the environmental information.

Acquiring environmental information of environment where the unmanned aerial vehicle is located may be referred to S601.

A process that the flight controller 211 determines the audio prompt information corresponding to the environmental information according to the environmental information of the environment where the unmanned aerial vehicle is located after the flight controller 211 determines the environmental information of the environment where the unmanned aerial vehicle is located may be similar to a process that the flight controller 211 determines the audio prompt information corresponding to the status information according to the status information of the unmanned aerial vehicle.

In the present disclosure, the environmental information of the environment where the unmanned aerial vehicle is located may be acquired through the unmanned aerial vehicle. The audio prompt control instruction may be produced according to the environmental information of the environment where the unmanned aerial vehicle is located and may be sent to the ground terminal device. The ground terminal device may perform the audio prompt according to the audio prompt control instruction. Coverage of the audio prompt from the unmanned aerial vehicle by the propeller sound of the unmanned aerial vehicle may be avoided, and the audio prompt played by the ground terminal device may effectively prompt users of the environmental status of the unmanned aerial vehicle.

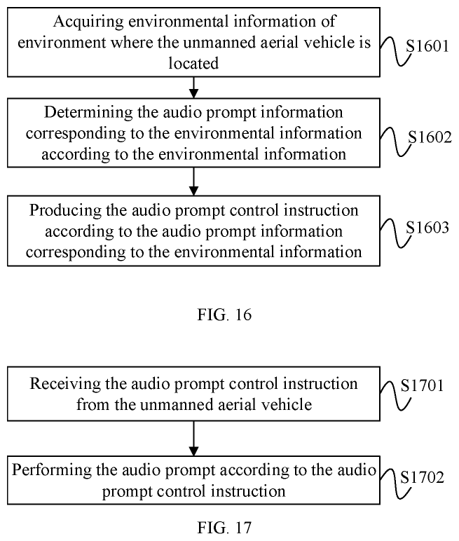

The present disclosure provides another method for prompting information of the unmanned aerial vehicle. The method may be applied to the ground terminal device. As illustrated in FIG. 17, the method may include:

S1701: receiving the audio prompt control instruction from the unmanned aerial vehicle; and

S1702: performing the audio prompt according to the audio prompt control instruction.

The execution subject of the method provided by the present embodiment of the present disclosure may be the ground terminal device. The ground terminal device may receive the audio prompt control instruction from the unmanned aerial vehicle. The audio prompt control instruction may be any audio prompt control instruction in various embodiments of the present disclosure.

In one embodiment, the audio prompt control instruction may be produced according to the status information of the unmanned aerial vehicle by the unmanned aerial vehicle, and may include the audio prompt information corresponding to the status information of the unmanned aerial vehicle.

In another embodiment, the audio prompt control instruction may be produced according to the environment information of the environment where the unmanned aerial vehicle is located by the unmanned aerial vehicle, and may include the audio prompt information corresponding to the environmental information.

Performing the audio prompt according to the audio prompt control instruction may include performing the audio prompt according to the audio prompt information in the audio prompt control instruction. For example, the flight controller 211 may send the audio prompt control instruction determined by the flight controller 211 according to the status information of the unmanned aerial vehicle 21 to the ground terminal device 22 through the communication system 213. When the communication interface 221 of the ground terminal device 22 receives the audio prompt control instruction, the audio prompt control instruction may be transmitted to the processor 222. The processor 222 may parse out the audio prompt information from the audio prompt control instruction and send the audio prompt information to the acoustics module 223 in the ground terminal device 22, to make the acoustics module 223 perform the audio prompt.

Performing the audio prompt according to the audio prompt information in the audio prompt control instruction may include sending the audio prompt information in the audio prompt control instruction to the acoustics module connected to the ground terminal device, to make the acoustics module perform the audio prompt. For example, the flight controller 211 may send the audio prompt control instruction determined by the flight controller 211 according to the status information of the unmanned aerial vehicle 21 to the ground terminal device 22 through the communication system 213. When the communication interface 221 of the ground terminal device 22 receives the audio prompt control instruction, the audio prompt control instruction may be transmitted to the processor 222. The processor 222 may parse out the audio prompt information from the audio prompt control instruction and send the audio prompt information to the acoustics module 225 externally connected to the ground terminal device 22, to make the acoustics module 225 perform the audio prompt.

The acoustics module may include at least one of a speaker or a buzzer.

In one embodiment, the method may further include: detecting a calibration setting operation of the user; and when the calibration setting operation is detected, audio prompting the user to perform the calibration setting. For example, when the component parameters of the unmanned aerial vehicle 21 including a bracket angle or a compass of the unmanned aerial vehicle 21 need calibration, the processor 222 of the ground terminal device 22 may control the acoustics module 223 or the acoustics module 225 to play audio prompt information corresponding to the calibration operation, to prompt users to control the ground terminal device 22 according to the calibration operation played by the acoustics module. When the ground terminal device 22 is a remote controller of the unmanned aerial vehicle 21, the users may control a joystick of the remote controller according to the calibration operation played by the acoustics module, to calibrate the bracket angle or the compass.

In another embodiment, the method may further include: detecting a selfie operation; and when the selfie operation is detected, audio prompting the user to adjust a photography posture. For example, the user may use the ground terminal device 22 to control the photographing device coupled to coupled to the unmanned aerial vehicle to photograph the user. The unmanned aerial vehicle may send the audio prompt information to the ground terminal device 22 according to a position of the user in the image, to make the ground terminal device 22 perform audio prompt to remind the user to adjust the posture or position.

In another embodiment, the method may further include: detecting flight control operation of the user; when flight control operation of the user is detected, audio prompting the user to operate the ground terminal device to control the flight of the unmanned aerial vehicle. For example, the ground terminal device 22 may be a remote controller of the unmanned aerial vehicle 21, and a control mode selection button may be disposed at the remote controller of the unmanned aerial vehicle 21. If a fresh user just getting started is not familiar with the remote controller and cannot control the flight of the unmanned aerial vehicle 21 stably, the user can click the control mode selection button disposed at the remote controller of the unmanned aerial vehicle 21. The remote controller may control the acoustics module in the remote controller to play voice instructions, to prompt the user how to operate the remote controller to control the unmanned aerial vehicle.

In the present disclosure, the ground terminal device may receive the audio prompt control instruction from the unmanned aerial vehicle. The ground terminal device may perform the audio prompt according to the audio prompt control instruction. Coverage of the audio prompt from the unmanned aerial vehicle by the propeller sound of the unmanned aerial vehicle may be avoided, and the audio prompt played by the ground terminal device may effectively prompt users of the environmental status of the unmanned aerial vehicle.

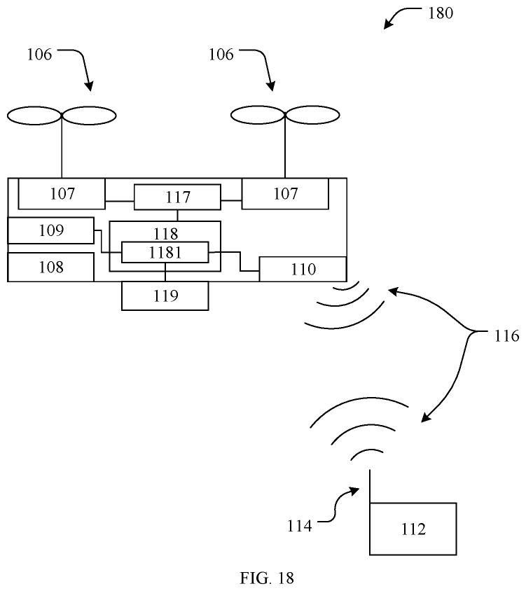

The present disclosure also provides an unmanned aerial vehicle. As illustrated in FIG. 18, the unmanned aerial vehicle 180 may include a vehicle body, a propulsion system, a flight controller 118, a sensor system 108, and a communication system 110.

The propulsion system may include at least one of a motor 107, a propeller 106, and an electron speed regulator 117. The propulsion system may be coupled to the vehicle body to provide flight propulsion.

The flight controller 118 may be connected to the propulsion system communicatively, to control the flight of the unmanned aerial vehicle. The flight controller 118 may include one or more processor 1181. The one or more processor 1181 may be used to acquire the status information of the unmanned aerial vehicle.

The sensor system 108 may be used to detect the status information of the unmanned aerial vehicle.

The communication system 110 may be connected to the flight controller 118 communicatively, and may be used to transmitted the status information of the unmanned aerial vehicle 180 to the ground terminal device 112. The ground terminal device 112 may acquire the audio prompt information corresponding to the status information, and may perform the audio prompt according to the audio prompt information.

The communication system 110 may include a receiver, and the receiver may be used to receive the wireless signal from an antenna 114 of the ground terminal device 112. Electromagnetic wave 116 may be generated in the communication between the receiver and the antenna 114.

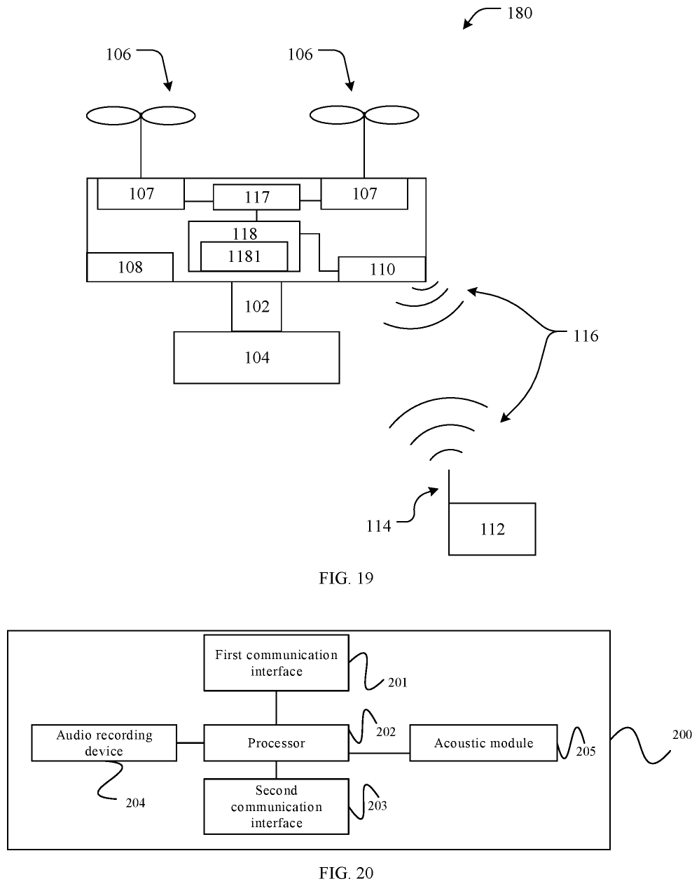

In some other embodiments, the unmanned aerial vehicle 180 may further include: a support device 102 and a photographing device 104, as illustrated in FIG. 19. The support device 102 may be a gimbal.

When the one or more processor 1181 acquires the status information of the unmanned aerial vehicle, the one or more processor 1181 may acquire flight status parameters of the unmanned aerial vehicle measured by the sensor system of the unmanned aerial vehicle, and then determine the status information of the unmanned aerial vehicle according to the flight status parameters of the unmanned aerial vehicle.

In one embodiment, the sensor system of the unmanned aerial vehicle may include at least one of a satellite position system, a barometer, an accelerometer, an inertial measurement unit, a magnetic field sensor, an ultrasonic sensor, a vision sensor, or a TOF sensor.

The flight status parameters of the unmanned aerial vehicle may include at least one of position information, acceleration, speed, attitude, or altitude relative to the ground.

In one embodiment, the status information of the unmanned aerial vehicle may include the flight status parameters of the unmanned aerial vehicle.

In one embodiment, a process that the one or more processor 1181 determines the status information of the unmanned aerial vehicle according to the flight status parameters of the unmanned aerial vehicle may include at least one of: determining whether the unmanned aerial vehicle is in a take-off state according to the flight status parameters of the unmanned aerial vehicle; determining whether the unmanned aerial vehicle is in a cruise state according to the flight status parameters of the unmanned aerial vehicle; or determining whether the unmanned aerial vehicle is in a landing state according to the flight status parameters of the unmanned aerial vehicle.

In another embodiment, the status information of the unmanned aerial vehicle may include failure information of the unmanned aerial vehicle. The flight controller may also determine whether the unmanned aerial vehicle is in a fault state according to the flight status parameters of the unmanned aerial vehicle.

In another embodiment, the status information of the unmanned aerial vehicle may include the obstacle information around the unmanned aerial vehicle.

In one embodiment, the one or more processor 1181 may be used to acquire environmental information of environment where the unmanned aerial vehicle is located through the sensor system of the unmanned aerial vehicle. The communication system may be used to transmit the environmental information to the ground terminal device, to make the ground terminal device determine audio prompt information corresponding to the environmental information and perform audio prompt according to the audio prompt information.

The sensor system may include at least one of a barometer, a wind speed sensor, a temperature sensor, or an atmospheric density sensor.

The environmental information of the environment where the unmanned aerial vehicle is located may include at least one of atmospheric temperature, atmospheric pressure, atmospheric density, or wind speed.

In one embodiment, the unmanned aerial vehicle 180 may further include an acoustics module 119 connected to the one or more processor 1181 communicatively. The one or more processor 1181 may be used to determine whether the unmanned aerial vehicle arrives at a preset destination according to the positioning information of the unmanned aerial vehicle, and to transmit the prompt information to the ground terminal device when the unmanned aerial vehicle arrives at the preset destination through the communication system. The prompt information may be used to prompt the users that the unmanned aerial vehicle arrives at the preset destination. The communication system may be also used to receive the audio information sent by the ground terminal device, and may transmit the audio information to the one or more processor 1181. The one or more processor 1181 may control the acoustics module 119 to broadcast the audio information sent by the ground terminal device.

The audio information may be the audio information recorded by an audio recording device in the ground terminal device.

In one embodiment, the one or more processor 1181 may be used to determine whether the unmanned aerial vehicle arrives at a preset destination according to the positioning information of the unmanned aerial vehicle, and to transmit the audio information to the ground terminal device when the unmanned aerial vehicle arrives at the preset destination through the communication system, to make the ground terminal device play the audio information.

The unmanned aerial vehicle 180 may further include an audio recording device connected to the one or more processor 1181 communicatively. The audio information may be the audio information recorded by the audio recording device of the unmanned aerial vehicle.

The principle and achievement of the unmanned aerial vehicle can be referred to the discussion in FIGS. 1-8.

In the present disclosure, the status information of the unmanned aerial vehicle may be acquired and transmitted to the ground terminal device. The ground terminal device may acquire the audio prompt information corresponding to the status information according to the status information of the unmanned aerial vehicle, and then perform audio prompt according to the audio prompt information. Covering of Audio prompt from the unmanned aerial vehicle by the propeller sound of the unmanned aerial vehicle may be avoided, and the audio prompt played by the ground terminal device may effectively prompt users of the status of the unmanned aerial vehicle.

The present disclosure also provides a ground terminal device. As illustrated in FIG. 20, the ground terminal device 200 may include a first communication interface 201 and a processor 202. The first communication interface 201 may be used to receive the status information of the unmanned aerial vehicle from the unmanned aerial vehicle. The processor may be used to acquire the audio prompt information corresponding to the status information according to the status information of the unmanned aerial vehicle, and control the acoustics module to perform audio prompt according to the audio prompt information.

In one embodiment, a process that the processor 202 acquires the audio prompt information corresponding to the status information according to the status information of the unmanned aerial vehicle may include: querying a preset one-to-one correspondence between a plurality of reference status information and a plurality of audio prompt information according to the status information of the unmanned aerial vehicle, to acquire the audio prompt information corresponding to reference status information matching the status information of the unmanned aerial vehicle.

In another embodiment, a process that the processor 202 acquires the audio prompt information corresponding to the status information according to the status information of the unmanned aerial vehicle may include: acquiring the audio prompt information corresponding to the status information from the internet.

In one embodiment, a process that the processor 202 acquires the audio prompt information corresponding to the status information from the internet may include: querying a preset one-to-one correspondence between a plurality of reference status information and a plurality of links according to the status information of the unmanned aerial vehicle, to acquire a link corresponding to the reference status information matching the status information of the unmanned aerial vehicle, where each link of the plurality of links points to an audio prompt information; and controlling the first communication interface 201 to acquire the audio prompt information indicated by the link from the internet according to the link corresponding to the reference status information matching the status information of the unmanned aerial vehicle from the internet.

In one embodiment, the status information of the unmanned aerial vehicle may include the flight status parameters of the unmanned aerial vehicle.

In one embodiment, the flight status parameters of the unmanned aerial vehicle may include at least one of the positioning information, the acceleration, the speed, the attitude, or the altitude relative to the ground.

In another embodiment, the status information of the unmanned aerial may include at least one of: the unmanned aerial vehicle is in a take-off state, the unmanned aerial vehicle is in a cruise state, or the unmanned aerial vehicle is in a landing state.

In another embodiment, the status information of the unmanned aerial vehicle may include failure information of the unmanned aerial vehicle.

In another embodiment, the status information of the unmanned aerial vehicle may include the obstacle information around the unmanned aerial vehicle.

The first communication interface 201 may receive the environmental information from the unmanned aerial vehicle. Then the processor 202 may acquire the audio prompt information corresponding to the environmental information according to the environmental information, and control the acoustics module to perform the audio prompt according to the audio prompt information.

The environmental information of the environment where the unmanned aerial vehicle is located may include at least one of atmospheric temperature, atmospheric pressure, atmospheric density, or wind speed.

In one embodiment, the ground terminal device 200 may include a second communication interface 203 connected to the acoustics module communicatively. A process that the processor 202 that controls the acoustics module to perform the audio prompt according to the audio prompt information may include that the processor 202 sends the audio prompt information to the acoustics module through the second communication interface 203, to make the acoustics module perform the audio prompt.

The acoustics module may include at least one of a speaker or a buzzer.

In one embodiment, the processor 202 may determine whether the unmanned aerial vehicle arrives at a preset destination according to the positioning information of the unmanned aerial vehicle. When the processor 202 determines that the unmanned aerial vehicle arrives at the preset destination, the processor 202 may send an audio information to the unmanned aerial vehicle through the first communication interface 201, to make the unmanned aerial vehicle broadcast the audio information.

The ground terminal device 200 may further include an audio recording device 204 connected to the process 202 communicatively. The audio information may be the audio information recorded by the audio recording device 204 of the ground terminal device.

The ground terminal device 200 may further include an acoustics module 205 connected to the processor 202 communicatively. The processor 202 may determine whether the unmanned aerial vehicle arrives at a preset destination according to the positioning information of the unmanned aerial vehicle. When the processor 202 determines that the unmanned aerial vehicle arrives at the preset destination, the processor 202 may send a prompt information to the unmanned aerial vehicle through the first communication interface 201. The prompt information may be used to indicate that the unmanned aerial vehicle arrives at the preset destination. The first communication interface 201 may be used to receive the audio information sent by the unmanned aerial vehicle, and send the audio information to the processor 202. The processor 202 may play the audio information sent by the unmanned aerial vehicle through the acoustics module 205.

The audio information may be the audio information recorded by the audio recording device of the unmanned aerial vehicle.

The working principle and the achievement of the ground terminal device can be referred to the embodiments illustrated in FIGS. 9-13.

In the present disclosure, the status information of the unmanned aerial vehicle may be acquired by the unmanned aerial vehicle and transmitted to the ground terminal device. The ground terminal device may acquire the audio prompt information corresponding to the status information according to the status information of the unmanned aerial vehicle, and then perform audio prompt according to the audio prompt information. Covering of the audio prompt from the unmanned aerial vehicle by the propeller sound of the unmanned aerial vehicle may be avoided, and the audio prompt played by the ground terminal device may effectively prompt users of the status of the unmanned aerial vehicle.

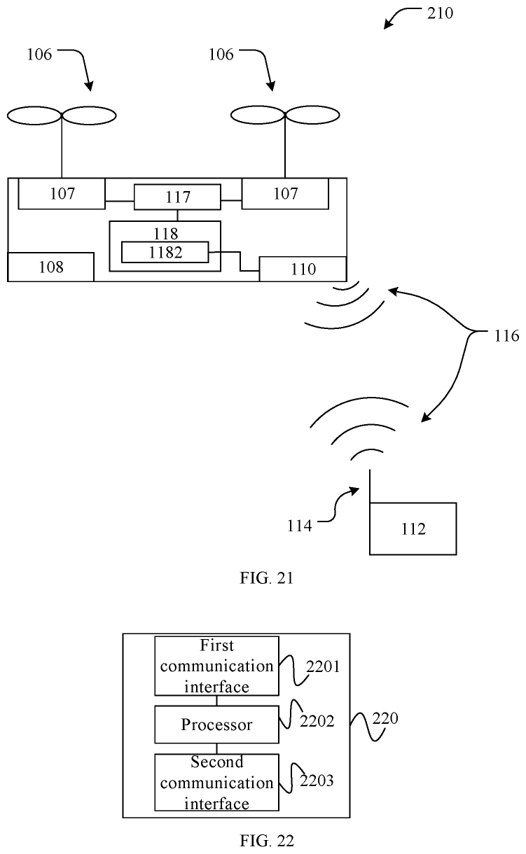

The present disclosure also provides another unmanned aerial vehicle. As illustrated in FIG. 21, the unmanned aerial vehicle 210 may include a vehicle body, a propulsion system, a flight controller 118, a sensor system 108, and a communication system 110.

The propulsion system may include at least one of a motor 107, a propeller 106, and an electron speed regulator 117. The propulsion system may be coupled to the vehicle body to provide flight propulsion.

The flight controller 118 may be connected to the propulsion system communicatively, to control the flight of the unmanned aerial vehicle. The flight controller 118 may include one or more processor 1182. The one or more processor 1182 may be used to acquire the status information of the unmanned aerial vehicle, and to produce an audio prompt control instruction according to the status information of the unmanned aerial vehicle.

The sensor system 108 may be used to detect the status information of the unmanned aerial vehicle.

The communication system 110 may be connected to the flight controller 118 communicatively, and may be used to transmit audio prompt control instruction to the ground terminal device 112. The ground terminal device 112 may perform the audio prompt according to the audio prompt control instruction.

The communication system 110 may include a receiver, and the receiver may be used to receive the wireless signal from an antenna 114 of the ground terminal device 112. Electromagnetic wave 116 may be generated in the communication between the receiver and the antenna 114.

A process that the one or more processor 1182 produces the audio prompt control instruction according to the status information of the unmanned aerial vehicle may include: acquiring the audio prompt information corresponding to the status information according to the status information of the unmanned aerial vehicle; and producing the audio prompt control instruction including the audio prompt information, according to the audio prompt information. The audio prompt control instruction may include the audio prompt information.

A process that the communication system sends the audio prompt control instruction to the ground terminal device to make the ground terminal device perform the audio prompt according to the audio prompt control instruction may include: sending the audio prompt control instruction to the ground terminal device to make the ground terminal device perform the audio prompt according to the audio prompt information in the audio prompt control instruction.

In one embodiment, a process that the one or more processor 1182 acquires the audio prompt information corresponding to the status information according to the status information of the unmanned aerial vehicle may include: querying a preset one-to-one correspondence between a plurality of reference status information and a plurality of audio prompt information according to the status information of the unmanned aerial vehicle, to acquire the audio prompt information corresponding to reference status information matching the status information of the unmanned aerial vehicle.

In another embodiment, a process that the one or more processor 1182 acquires the audio prompt information corresponding to the status information according to the status information of the unmanned aerial vehicle may include: acquiring the audio prompt information corresponding to the status information from the internet.

In one embodiment, a process that the one or more processor 1182 acquires the audio prompt information corresponding to the status information from the internet may include: querying a preset one-to-one correspondence between a plurality of reference status information and a plurality of links according to the status information of the unmanned aerial vehicle, to acquire a link corresponding to the reference status information matching the status information of the unmanned aerial vehicle, where each link of the plurality of links points to an audio prompt information; and controlling the communication system to acquire the audio prompt information indicated by the link from the internet according to the link corresponding to the reference status information matching the status information of the unmanned aerial vehicle from the internet.

In one embodiment, the one or more processor 1182 may be used to acquire the environmental information of the environment where the unmanned aerial vehicle is located, to determine the audio prompt information corresponding to the environmental information according to the environmental information; and to produce the audio prompt control instruction according to the audio prompt information corresponding to the environmental information.

In the present disclosure, the status information of the unmanned aerial vehicle may be acquired through the unmanned aerial vehicle, and the audio prompt control instruction may be produced according to the status information of the unmanned aerial vehicle and may be sent to the ground terminal device. The ground terminal device may perform the audio prompt according to the audio prompt control instruction. Coverage of the audio prompt from the unmanned aerial vehicle by the propeller sound of the unmanned aerial vehicle may be avoided, and the audio prompt played by the ground terminal device may effectively prompt users of the environmental status of the unmanned aerial vehicle.

The present disclosure also provides another ground terminal device. As illustrated in FIG. 22, the ground terminal device 220 may include a first communication interface 2201 and a processor 2202. The first communication interface 2201 may be used to receive the audio prompt control instruction sent by the unmanned aerial vehicle. The processor 2202 may be used to control the acoustics module to perform audio prompt according to the audio prompt control instruction.

In one embodiment, the audio prompt control instruction may be produced according to the status information of the unmanned aerial vehicle. The audio prompt control instruction may include the audio prompt information corresponding to the status information of the unmanned aerial vehicle.

In another embodiment, the audio prompt control instruction may be produced according to the environmental information of the environment where the unmanned aerial vehicle is located. The audio prompt control instruction may include the audio prompt information corresponding to the environmental information.

In one embodiment, a process that the processor 2202 controls the acoustics module to perform audio prompt according to the audio prompt control instruction may include: controlling the acoustics module to perform the audio prompt according to the audio prompt information in the audio prompt control instruction.

In one embodiment, the ground terminal device 202 may further include a second communication interface 2203 connected to the acoustics module communicatively. A process the processor 2202 that controls the acoustics module to perform the audio prompt according to the audio prompt information in the audio prompt control instruction may include that the processor 2202 sends the audio prompt information in the audio prompt control instruction to the acoustics module through the second communication interface 2203, to make the acoustics module perform the audio prompt.

The acoustics module may include at least one of a speaker or a buzzer.

In one embodiment, the processor 2202 may be also used to: detecting a calibration setting operation of the user; and when the calibration setting operation is detected, audio prompting the user to perform the calibration setting.

In another embodiment, the processor 2202 may be also used to: detecting a selfie operation; and when the selfie operation is detected, audio prompting the user to adjust a photography posture.

In another embodiment, the processor 2202 may be also used to: detecting a flight control operation of the user; when flight control operation of the user is detected, audio prompting the user to operate the ground terminal device to control the flight of the unmanned aerial vehicle.

The working principle and the achievement of the ground terminal device can be referred to the embodiments illustrated in FIG. 17.

In the present disclosure, the ground terminal device may receive the audio prompt control instruction from the unmanned aerial vehicle, and then perform audio prompt according to the audio prompt control instruction. Covering of the audio prompt from the unmanned aerial vehicle by the propeller sound of the unmanned aerial vehicle may be avoided, and the audio prompt played by the ground terminal device may effectively prompt users of the status of the unmanned aerial vehicle.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for prompting information of an unmanned aerial vehicle, being applied to the unmanned aerial vehicle, the method comprising:
acquiring status information of the unmanned aerial vehicle; and
transmitting the status information of the unmanned aerial vehicle to a ground terminal device, such that the ground terminal device acquires audio prompt information corresponding to the status information according to the status information of the unmanned aerial vehicle and performs an audio prompt according to the audio prompt information.

2. The method according to claim 1, wherein acquiring the status information of the unmanned aerial vehicle includes:
acquiring flight status parameters of the unmanned aerial vehicle measured by a sensor system of the unmanned aerial vehicle; and
determining the status information of the unmanned aerial vehicle according to the flight status parameters of the unmanned aerial vehicle.

3. The method according to claim 2, wherein the sensor system of the unmanned aerial vehicle includes at least one of a satellite position system, a barometer, an accelerometer, an inertial measurement unit, a magnetic field sensor, an ultrasonic sensor, a vision sensor, or a time-of-flight sensor.

4. The method according to claim 3, wherein the flight status parameters of the unmanned aerial vehicle include at least one of position information, acceleration, speed, attitude, or altitude relative to the ground.

5. The method according to claim 2, wherein:
the status information of the unmanned aerial vehicle includes the flight status parameters of the unmanned aerial vehicle.

6. The method according to claim 2, wherein determining the status information of the unmanned aerial vehicle according to the flight status parameters of the unmanned aerial vehicle includes at least one of:
determining whether the unmanned aerial vehicle is in a take-off state according to the flight status parameters of the unmanned aerial vehicle;
determining whether the unmanned aerial vehicle is in a cruise state according to the flight status parameters of the unmanned aerial vehicle; or
determining whether the unmanned aerial vehicle is in a landing state according to the flight status parameters of the unmanned aerial vehicle.

7. The method according to claim 1, wherein:
the status information of the unmanned aerial vehicle includes fault information of the unmanned aerial vehicle.

8. The method according to claim 1, wherein the status information of the unmanned aerial vehicle includes obstacle information around the unmanned aerial vehicle.

9. The method according to claim 1, further including:
acquiring environmental information of environment where the unmanned aerial vehicle is located through a sensor system of the unmanned aerial vehicle; and
transmitting the environmental information to the ground terminal device, to make the ground terminal device determine audio prompt information corresponding to the environmental information and perform audio prompt according to the audio prompt information.

10. The method according to claim 9, wherein the sensor system includes at least one of a barometer, a wind speed sensor, a temperature sensor, or an atmospheric density sensor.

11. The method according to claim 9, wherein the environmental information of the environment where the unmanned aerial vehicle is located includes at least one of atmospheric temperature, atmospheric pressure, atmospheric density, or wind speed.

12. The method according to claim 4, further including:
determining whether the unmanned aerial vehicle arrives at a preset destination according to the positioning information of the unmanned aerial vehicle;
transmitting prompt information to the ground terminal device when the unmanned aerial vehicle arrives at the preset destination, wherein the prompt information is used to indicate that the unmanned aerial vehicle arrives at the preset destination; and
receiving and broadcasting audio information from the ground terminal device.

13. The method according to claim 12, wherein:
the audio information is audio information recorded by the ground terminal device using an audio recording device.

14. The method according to claim 12, wherein:
broadcasting the audio information from the ground terminal device includes using an acoustics module of the unmanned aerial vehicle to broadcast the audio information from the ground terminal device.

15. The method according to claim 4, further including:
determining whether the unmanned aerial vehicle arrives at a preset destination according to positioning information of the unmanned aerial vehicle; and
when the unmanned aerial vehicle arrives at the preset destination, transmitting audio information to the ground terminal device to make the ground terminal device play the audio information.

16. The method according to claim 15, wherein:
the audio information is audio information recorded by an audio recording device of the unmanned aerial vehicle.

17. An unmanned aerial vehicle, comprising:
a vehicle body;
a propulsion system on the vehicle body for providing flight propulsion;
a flight controller connected to the propulsion system by communication;
a sensor system; and
a communication system connected to the flight controller by communication,
wherein:
the flight controller is configured to control flight of the unmanned aerial vehicle, and includes one or more processors for acquiring status information of the unmanned aerial vehicle;
the sensor system is configured to detect the status information of the unmanned aerial vehicle
the communication system is configured to transmit the status information of the unmanned aerial vehicle to a ground terminal device, to make the ground terminal device acquire audio prompt information corresponding to the status information and perform audio prompt according to the audio prompt information;
the one or more processors for acquiring status information of the unmanned aerial vehicle is configured to acquire flight status parameters of the unmanned aerial vehicle detected by the sensor system of the unmanned aerial vehicle;
the status information of the unmanned aerial vehicle is determined according to the flight status parameters of the unmanned aerial vehicle;
the one or more processor is further configured to acquire environmental information of environment where the unmanned aerial vehicle is located detected by the sensor system of the unmanned aerial vehicle; and
the communication system is further configured to transmit the environmental information to the ground terminal device, to make the ground terminal device determine audio prompt information corresponding to the environmental information and perform audio prompt according to the audio prompt information.

18. The unmanned aerial vehicle according to claim 17, further including an acoustics module connected to the one or more processors communicatively, wherein:
the one or more processor is further configured to determine whether the unmanned aerial vehicle arrives at a preset destination according to the positioning information of the unmanned aerial vehicle;
the communication system is further configured to: transmit prompt information to the ground terminal device when the unmanned aerial vehicle arrives at the preset destination, wherein the prompt information is used to indicate that the unmanned aerial vehicle arrives at the preset destination; and to receive audio information from the ground terminal device and transmit the audio information to the one or more processor; and
the one or more processor is further configured to broadcast the audio information from the ground terminal device using the acoustics module.

19. A ground terminal device, comprising a first communication interface and a processor, wherein:
the first communication interface is configured to receive status information of an unmanned aerial vehicle from the unmanned aerial vehicle;
the processor is configured to acquire audio prompt information corresponding to the status information according to the status information of the unmanned aerial vehicle, and control an acoustics module to perform audio prompt according to the audio prompt information;
wherein:
the processor is configured to query a preset one-to-one correspondence between a plurality of reference status information and a plurality of audio prompt information according to the status information of the unmanned aerial vehicle, to acquire the audio prompt information corresponding to reference status information matching the status information of the unmanned aerial vehicle; or
the processor is configured to acquire the audio prompt information corresponding to the status information from the internet by querying a preset one-to-one correspondence between a plurality of reference status information and a plurality of links according to the status information of the unmanned aerial vehicle, to acquire a link corresponding to the reference status information matching the status information of the unmanned aerial vehicle, wherein each link of the plurality of links points to an audio prompt information.

20. The device according to claim 19, wherein:
the first communication interface is further configured to receive environmental information of environment where the unmanned aerial vehicle is located from the unmanned aerial vehicle; and
the processor is further configured to acquire audio prompt information corresponding to the environmental information according to the environmental information, and control the acoustics module to perform the audio prompt according to the audio prompt information.
